(19) United States
(12) Patent Application Publication
(10) Pub. No.: US 2009/0176909 A1
(43) Pub. Date: Jul. 9, 2009

(54) HYDROGEL WITH HIGH WATER CONTENT AND STABILITY

(75) Inventor: Patrick H. Benz, Sarasota, FL (US)

Correspondence Address: FOLEY AND LARDNER LLP;SUITE 500, 3000 K STREET NW, WASHINGTON, DC, 20007, US

(73) Assignee: Benz Research and Development Corp.

(21) Appl. No.: 12/248,823

(22) Filed: Oct. 9, 2008

Related U.S. Application Data
(60) Provisional application No. 60/978,858, filed on Oct. 10, 2007.

(51) Int. Cl. G02B 1/04; C08F 122/20; C08L 33/14; C08L 33/24; C08F 20/56; G02C 7/04

(52) U.S. Cl. 523/106; 526/320; 525/223; 525/218; 526/307.5; 524/523; 524/558; 524/521; 351/160 H

(57) ABSTRACT

A polymer comprising hydrophilic and hydrophobic properties is provided. The polymer can be formed into a hydrogel capable of being used as a contact lens. The lens can exhibit high water content such as for example more than 70 wt. % for biocompatibility and structural stability for handling. The hydrophilic portion can be 2,3-dihydroxypropyl methacrylate (GMA) and the hydrophobic portion can be 2-methoxyethyl methacrylate (MOEMA). Additionally, the lens can also include N,N-dimethylacrylamide (NN-DMA). Lens can be prepared and formed by molding including a cast molding process or a half cast molding process.

### RELATED APPLICATIONS

This application claims priority to U.S. provisional application Ser. No. 60/978,858 filed Oct. 10, 2007, which is hereby incorporated by reference in its entirety.

### BACKGROUND

Hydrogels can be understood as water-containing crosslinked polymer matrices. Hydrogels can be used in applications involving the eye including as contact lenses.

Although advances have been made with hydrogels for use in eye applications, a need yet exists for polymers and hydrogels which provide a combination or balance of properties. See for example U.S. Pat. No. 6,096,799 (Benz Research and Development Corp.). For example, one or more useful properties can include high water content, good hydration and dehydration behavior including drying rates, optical clarity, mechanical properties such as strength, and machinability. Unfortunately, attempts to achieve one or more useful properties can result in taking away one or more other useful properties. For example, if a hydrogel comprises both a hydrophilic component and a hydrophobic component, the hydrogel may generate phase separation and cloudiness. In another example, machinability may be compromised. In other cases, difficulty may arise in finding the right balance of hydration rate coupled with dehydration rate.

### SUMMARY

Provided herein are compositions and devices, and methods of making and using the compositions and devices. For example, a polymer comprising hydrophilic and hydrophobic properties is provided. The polymer can be formed into a hydrogel that is capable of being used as a contact lens. Also provided are methodology for making and using the hydrogel lens.

One embodiment provides a composition comprising at least one polymer prepared from at least the following monomers:

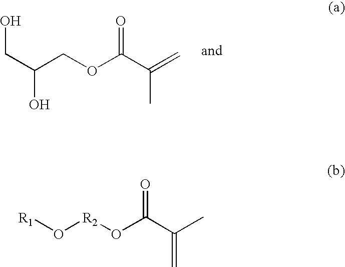

wherein R₁=—CH₃ or —CH₂CH₃ and R₂=CH₂— or —CH₂—CH₂— or —CH₂—CH₂—CH₂—; but wherein the polymer is not prepared from hydroxyethyl methacrylate (HEMA).

Another embodiment provides a composition adapted for high hydrogel water content consisting essentially of at least one polymer prepared from at least the following monomers:

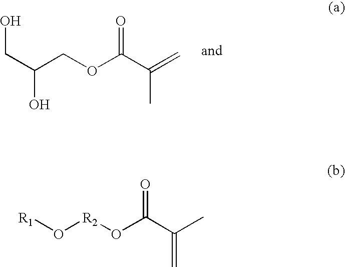

wherein R₁=—CH₃ or —CH₂CH₃ and R₂=CH₂— or —CH₂—CH₂— or —CH₂—CH₂—CH₂—, wherein the water content is at least about 60 wt. % and any HEMA if used in the polymer preparation is about 2 wt. % or less with respect to the total amount of polymerizable monomers.

One or more of the materials and polymers described herein can provide at least one advantage including, for example, high water content, strength enough to withstand handling and machining, better machinability, transparency, optical properties suitable for use as a lens, as well as combinations of these and other properties.

### BRIEF DESCRIPTION OF THE FIGURES

FIG. 1 illustrates In Vivo dehydration of different high water content materials. The inventive material is at the far left (99%).

FIG. 2 illustrates Dk of materials based on measured water content of lens on-the-eye, using Young and Benjamin's approximation equation [Log(Dk)=0.01754(WC)+0.3897]. The ULTRA O₂ and ULTRA O₂ Plus and UO₂ and UO₂ Plus materials are according to the invention.

FIG. 3 illustrates comparison of Relative water balance ratio with water content.

FIG. 4 shows contact angle measurements reflecting wettability including Benz ULTRA O₂ Plus compared to competitive silicon hydrogel.

### DETAILED DESCRIPTION

### Introduction

All references cited herein are incorporated by reference in their entirety.

Priority U.S. provisional application Ser. No. 60/978,858 filed Oct. 10, 2007 is hereby incorporated by reference in its entirety including claims, working examples, and descriptive embodiments.

Contact lens are described in, for example, U.S. Pat. Nos. 6,096,799 and 5,532,289 to Benz and Ors (Benz Research and Development Corp.). See also, for example, U.S. Pat. Nos. 7,067,602; 6,627,674; 6,566,417; 6,517,750; 6,267,784; and 5,891,932. Additional contact lens patents include U.S. Pat. Nos. 6,599,959; 6,555,598; 6,265,465; 6,245,830; 6,242,508; and 6,011,081. See also U.S. Pat. No. 5,532,289 for water balance measurements. One skilled in the art can resort to these references for use in formulating compositions, polymerizing compositions, molding and forming compositions, types of contact lenses, and measuring physical properties.

Polymers, crosslinked polymers, copolymers, terpolymers, hydrogels, interpenetrating polymer networks, random versus block microstructures, oligomers, monomers, methods of polymerization and copolymerization, molecular weight, measurements, and related materials and technologies are generally known in the polymer arts and can be used in the practice of the presently described embodiments. See, for example, (1) Contemporary Polymer Chemistry, Allcock and Lamp, Prentice Hall, 1981, and (2) Textbook of Polymer Science, 3^{rd} Ed., Billmeyer, Wiley-Interscience, 1984. Free radical polymerization can be used to prepare the polymers herein.

Hydration of crosslinked polymers is known in the art in various technologies including hydrogel, membrane, and lens materials.

Abbreviations:

GMA is glycerol methacrylate or 2,3-dihydroxypropyl methacrylate;

EOEMA is ethoxy ethyl methacrylate;

NN-DMA is N,N-dimethylacrylamide;

MOEMA is methoxy ethyl methacrylate;

PEG 200 is Poly(ethylene glycol), molecular weight about 200.

NMP is N-methylpyrrolidone.

TriEGDMA is triethyleneglycol dimethacrylate.

### Hydrophilic Monomer (A)

The polymer comprising the hydrogel can include monomers with vicinal hydroxyl groups such as 2,3-dihydroxyethyl methacrylate (GMA) as the hydrophilic portion. The structure of GMA before polymerization is provided below.

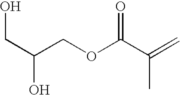

HEMA can be totally or substantially excluded from the monomers used to prepare the polymer. Small amounts of HEMA can be used in one embodiment to the extent the desired properties can be achieved. For a particular system, one skilled in the art can experiment to determine how much HEMA can be used such as for example less than 2 wt. %, or less than 1 wt. %, or less than 0.5 wt. %, or less than 0.1 wt. %, with respect to the total amount of polymerizable monomers.

### Hydrophobic Monomer (B)

The polymer comprising the hydrogel can include R₁—O—R₂-MA as the hydrophobic portion. The structure of R₁—O—R₂-MA is provided below.

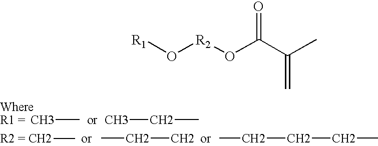

The different types of R₁—O—R₂-MA include 2-methoxyethyl methacrylate (MOEMA) and ethyoxyethyl methacrylate (EOEMA).

### Additional Components

At least one acrylamide monomer (c) can be used, including for example a di-substituted acrylamide such as for example N,N-dimethylacrylamide (NN-DMA), which structure is provided below, and can be included in the formulations.

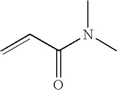

This component can increase water content. For example, this component can increase water content at least about 1 wt. %, or at least about 3 wt. %, or at least about 5 wt. %. For example, NN-DMA can increase the overall hydrophilicity of the hydrogel, and it also can help prevent or reduce the cloudiness associated with increased hydrophilicity in hydrophilic/hydrophobic combination hydrogels. It can participate in hydrogen bonding.

In another embodiment, non-reactive components such as a diluent or an organic solvent like for example an aprotic solvent like for example N-methyl pyrrolidone (NMP) can be used. This can be substantially non-reactive in the polymerization process. A diluent like NMP can be used to reduce the viscosity. It can also improve random mixing of the various components.

In addition, a polymer or oligomer can be added, including a water soluble or hydrophilic polymer or oligomer such as for example poly(ethylene glycol) (PEG). This can be substantially non-reactive in the polymerization process. The polymer or oligomer can comprise a heteroatom in the repeat unit such as oxygen. It can participate in hydrogen bonding. The molecular weight can be for example about 100 to about 500, or about 200 to about 400, or about 200.

Materials like NMP and PEG can leach out or substantially leach out of the hydrated material. PEG can be eliminated in embodiments where machining is not needed.

Crosslinking agents can be used in polymerizing the hydrogel. Difunctional and trifunctional crosslinkers can be used for example. Crosslinkers can be selected so they may or may not fully crosslink in the allotted polymerization time. One skilled in the art can adapt polymerization time so that coupling of chain by crosslinking can be adapted. Known cross-linking agents, for example, as taught in U.S. Pat. No. 4,038,264 to Rostoker et al., hereby incorporated by reference in its entirety for all purposes, can be used in the hydrogels provided. In one embodiment, tri(ethylene glycol) dimethacrylate (TriEGDMA) is used as a cross-linker.

An initiator can be used in polymerizing the hydrogel. Any initiator commonly used in the art can be used. In one embodiment, the initiator is 2,2′-azobis(2,4-dimethylpentane nitrile) is used in polymerizing the hydrogel.

### Amounts

The amounts of components (a) and (b), and of components (a), (b), and (c) can be varied to achieve the desired performance.

For example, the composition can comprise a polymer formed from at least (a) and (b), wherein the amount of (a) is about 60 wt. % to about 95 wt. % and the amount of (b) is about 5 wt. % to about 40 wt. % based on the total amount of polymerizable monomers.

In another example, the polymer is further prepared from (c) N,N-dimethylacrylamide, and wherein the amount of (c) is about 1 wt. % to about 20 wt. % based on the total amount of polymerizable monomers.

In another example, the polymer is further prepared from (c) N,N-dimethylacrylamide, and wherein the amount of (c) is about 1 wt. % to about 20 wt. % based on the total amount of polymerizable monomer, and wherein the amount of (a) is about 60 wt. % to about 95 wt. % and the amount of (b) is about 5 wt. % to about 40 wt. % based on the total amount of polymerizable monomers.

The working examples can be also used in describing the amounts of each of the components, and the amounts described therein can be varied by, for example, about 20% or less, or about 10% or less, or about 5% or less. For example, the amounts of initiator and crosslinker can be adapted as known in the art.

In addition, the composition can further comprise optionally at least one diluent and optionally at least polymer or oligomer such as poly(ethylene glycol), the diluent and the polymer or oligomer such as poly(ethylene glycol) each present in an amount of about 1 wt. % to about 10 wt. % with respect to the total amount of polymerizable monomer.

In addition, the composition can further comprise at least one diluent and at least polymer or oligomer such as poly(ethylene glycol), the diluent and the polymer or oligomer such as poly(ethylene glycol) each present in an amount of about 1 wt. % to about 10 wt. % with respect to the total amount of polymerizable monomer.

### Polymerization

Conventional polymerization methods can be used including application of heat and use of molds. Free radical methods and crosslinking methods can be used. Polymerization time can be for example about 1 h to about 48 hours.

Polymers can be removed from the molds and formed into contact lens buttons (blanks).

### Forming Lens

The polymers described and claimed herein can be formed into hydrogels, contact lens blanks, semi-finished contact lenses, or finished contact lenses. The contact lenses can be of any type including spheric, toric, multifocal, and bandage contact lenses. Lens can be prepared by molding including a cast molding process or a half cast molding process.

The hydrogel provided can be machined in the following manner.

### Properties

The hydrophilic properties of the hydrogel includes a relatively high water content, which allows it to be biocompatible and suitable for use in vivo. In addition, the hydrogel exhibits dehydration/rehydration properties that allows for a slow rate of dehydration and increased rate of rehydration to keep the hydrogel at or near water saturation levels. This characteristic allows the hydrogel to keep its dimensional stability and, when used as a lens, prevents an individual's eye from drying out.

The hydrophobic properties of the hydrogel include a strong structure, which allows it to be handled without causing physical damage. For example, when formed into a contact lens, the hydrophobic properties of the hydrogel allow the lens to withstand daily wear. Moreover, the hydrophobic properties also allow the hydrogel to withstand physical handling during processes to transform it into custom lenses, such as machining. Contrary to the prior art, the hydrogel can be machined or otherwise cut without any resulting micro- or nano-fractures in the hydrogel. Such fractures may become evident upon hydration of the polymer. If not formulated correctly, the polymer can be too brittle.

Additives like polymers and oligomers such as poly(ethylene glycol) can improve machinability or lathing. One can add materials like polymers, oligomers, such as PEG, to generate swarf or turnings, which are continuous, string-like in character rather than powdery chunks. Fewer defects can be achieved.

The hydrogel provided can have from about 70 to about 90 percent hydrophilic polymer by weight and can have from about 10 to about 25 percent hydrophobic polymer by weight. The hydrogel provided can also have from about 65 to about 75 percent water content.

The hydrogel provided can have a relative water balance (relative to poly(hydroxylethylmethacrylate) HEMA) from about 10 to about 18, or about 10 to about 16, or about 14 to about 16. This can be achieved at a water content of about 65 wt. % to about 75 wt. %. Prior art materials such as HEMA-GMA copolymers can have a relative water balance of only about 5.5 at a water content of about 60% wt.

Hydrogel water content can be for example at least 66 wt. %, or at least 70 wt. %, or at least 75 wt. %.

In one embodiment, the hydrogel comprises GMA as the hydrophilic portion and 2-methoxyethyl methacrylate (MOEMA) as the hydrophilic portion. The water content of this hydrogel can be about 70 percent.

In another embodiment, N,N-dimethylacrylamide (NN-DMA) is included with GMA and MOEMA. The water content of this hydrogel can be about 75 percent.

Unlike silicon materials, the hydrogels and contact lens described herein can be extremely biocompatible, soft, and wettable.

Also, the materials can be non-ionic.

Lenses made from these materials can maintain their hydration even at high water content. Lenses made from these materials can remain fully hydrated on-the-eye due to their excellent water binding properties. For example, patients can recognize the extended “no-blink” comfort when using a computer or when experiencing typical “dry-eye” conditions.

Materials prepared as described herein can have, for example, at least the following specifications:

water content (wt. %): 76

Dk (35° C., Fatt Units): at least 50

Refractive Index Dry: 1.509

Refractive Index Hydrated (35° C.): 1.376

Linear Expansion (mm): 1.600

Radial Expansion (mm): 1.600

% Transmission (@600 nm): >95

Materials can be adapted to be clear or colored, e.g., green with green pigment. Other pigments can be used.

UV blockers can be used if desired.

### ADDITIONAL DESCRIPTION

Additional references can help provide guidance to one skilled in the art as needed. For example, see also for example clinical studies by Businger in Contact Lens Spectrum, August 1995, pp. 19-25 and die Kontaklinsen 7-8, 4 (1997) regarding water retention and lens stability.

See also, Yasuda, et. al., Journal of Polymer Science: Part A1, 4, 2913-27 (1966) and Macret et. al., Polymer, 23(5) 748-753 (1982), which describe hydrogels based on HEMA and GMA.

Refojo, Journal of Applied Polymer Science, 9, 3161-70 (1965), describes hydrogels of high water content made from GMA. Wichterle, et. al., UK Patent GB 2196973A, reported the use of hydrophilic solvents, such as glycerol, dimethylformamide, and dimethylsulfoxide, in 2-HEMA blends primarily for the centrifugal casting of contact lenses.

See also, U.S. Pat. No. 6,267,784, hereby incorporated in its entirety for all purposes. See also, U.S. Pat. No. 5,326,506. See also U.S. Pat. Nos. 5,079,319; 4,218,554; and 4,432,366.

In addition, embodiment described in (1) U.S. patent application Ser. No. 12/042,317 filed Mar. 4, 2008 (035634-0213), and (2) PCT application PCT/U.S.08/61634 filed Apr. 25, 2008, each to Benz Research and Development can be adapted for use as described herein.

### Dehydration, Dk, Wettability, Water Balance, and Combinations of Properties in Commercial Setting

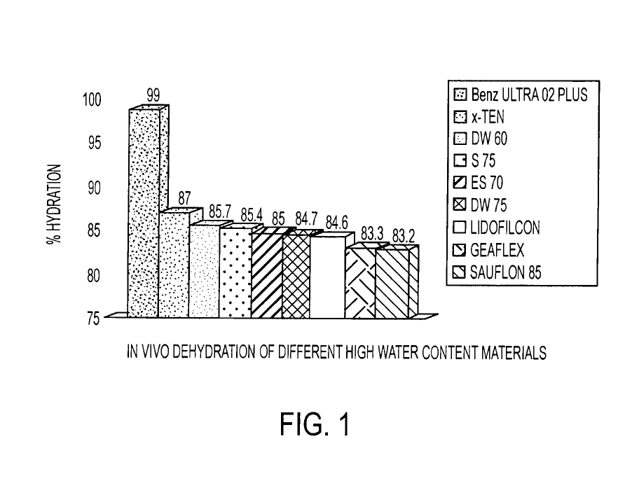

In Vivo studies are an important aspect of hydration and dehydration. See for example FIG. 1 for superior performance for materials according to the claimed inventions.

Another important consideration in the development of hydrogel-based contact lens materials can be the effect of the material on gas exchange in the eye. Gas exchange occurs through the cornea of the eye with oxygen being absorbed and carbon dioxide being given off. When the cornea is covered with a contact lens, gas exchange can only occur by diffusion (D) through the contact lens material. The diffusion of gas through a lens material over time can be described mathematically as Dk/T. Thus, when developing contact lens materials, efficient gas exchange, resulting in a higher Dk/T is, can be a primary goal.

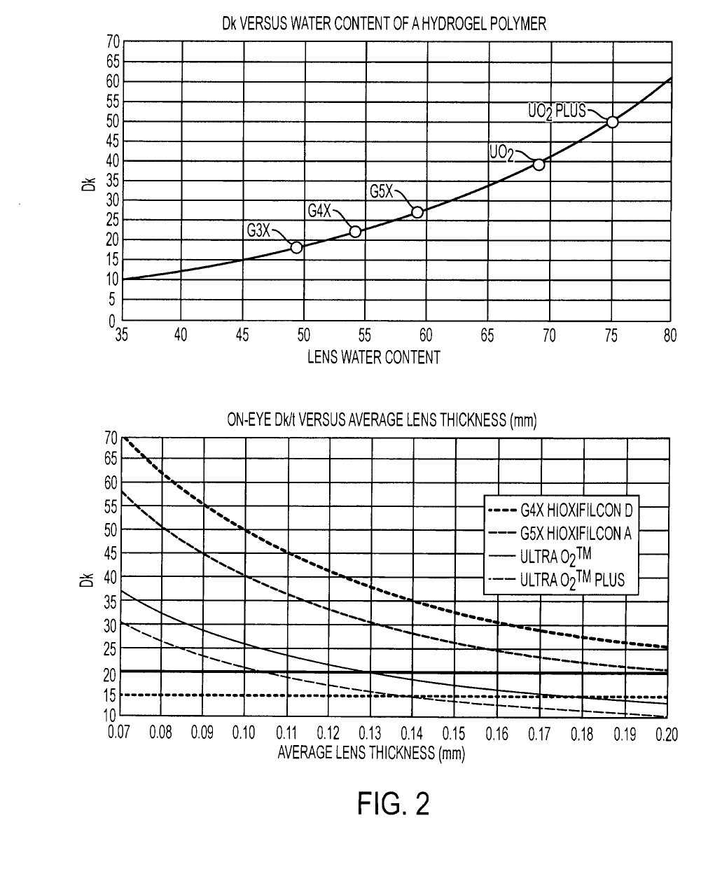

For example, the original work of Holden and Mertz in 1984 determined that the minimum requirement for daily wear soft lenses should be a Dk/T of 24. This value was obtained using both published and calculated oxygen transmissibility data of various first generation hydrogel lenses. Unfortunately, the Dk values used were for saturated lenses and were not corrected for water loss on-the-eye which is known to be 10-15% depending on the particular lens material. Correcting for water loss during wear would bring Holden's minimum Dk/T value closer to 20. This is precisely the value that Brennan found to be the minimum Dk/T required to prevent corneal swelling using RGP lenses as controls. RGP lenses are not dependent on water content for their Dk, therefore drying out during wear was not a variable. The clinical results of this physiologic effect of a lens's Dk on corneal swelling shows that corneal swelling disappears above a Dk/T of 20 for daily wear. Another significant clinical study by Brennan determined the physiologic affect of a lens's Dk/T on the percentage corneal oxygen consumption (% Q) and clearly shows that corneal oxygen consumption is at 100% of its maximum when a daily wear contact lens has a Dk/T of 20 or more. Therefore both of these clinical studies of corneal health, corneal swelling and percentage corneal oxygen consumption (% Q) clearly show that there is no significant clinically measurable oxygen transmissibility benefit to the cornea for daily wear lenses beyond a Dk/T of 20, It seems reasonable based on this important clinical data that 20 Dk/T can be or should be the oxygen transmissibility benchmark for high performance daily wear lenses. Materials as described herein make that benchmark (see for example FIG. 2).

Therefore, it is important to note that the water content on the eye versus Dk of a hydrogel lens material is clinically important when the material is in contact with the eye, as opposed to when the material is vial or blister pack. A material that does not dry out during wear is an important requirement of a high performance hydrogel, because as a lens loses water it “slides down” the oxygen transmissibility curve exponentially, losing oxygen permeability as its polymer matrix collapses. To that end, a desirable material can have a minimum Dk/T value of about 20 when in contact with the eye.

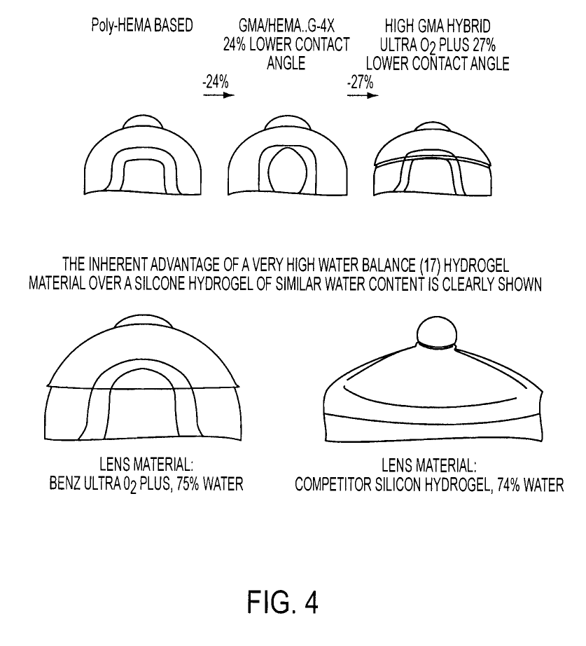

Wettability is also an important lens material property that can affect patient comfort and preference. Unlike the bulk polymer property, water balance, wettability is a surface property and its measurement can be significantly affected by surface active contaminants. In fact, current silicone hydrogels on the market can use either an added surface active component or chemically altered surface to make these polymers wettable. Therefore, one can measure the advancing contact angle of pure saline on a very clean lens hydrated and autoclaved in pure saline. One can call this the pure saline contact angle. The relative difference in pure saline contact angle of conventional poly-HEMA based polymers GMA/HEMA copolymers and a high GMA hybrid polymer can be measured (see, for example, FIG. 4, top and bottom). There can be a substantial difference in wettability between these lens materials. The more wettable the material is, the flatter the drop or the lower the contact angle. For the purpose of material comparison it is useful to examine the percent change in the pure saline contact angle between each material rather than a particular angle. The contact angle is reduced by 24% in going from a poly-HEMA based lens to a 54% GMA/HEMA copolymer lens. This amount of change in contact angle may be what is necessary for patients to consistently have a comfort preference between two materials, and lenses made of materials as described herein, being much more wettable than conventional materials, provide this advantage.

The materials described herein can be useful as high performance soft lens because, for example, they can be able to stay completely hydrated and dimensionally stable on the eye as well as extremely wettable. Staying hydrated during wear can mean that a 54% water high performance lens made of materials described herein can provide an oxygen transmission of 20 Dk/T at 105 microns average lens thickness, and a 75% water content lens made of materials described herein can provide 20 Dk/T all the way to 300 microns average lens thickness. This means that virtually any lens design, can be a high performance daily wear lens. Other custom lens material cannot make that claim because they lose water as soon as they are placed on the eye. Also, for a custom lens manufacturer, knowing that the precision lens you produced has the same exact dimension on a patient's eye has obvious benefits in lens design and fit as well as visual acuity.

These high performance lens properties are a function of the polymer's water compatibility. Water compatibility is a general term used here to describe a polymer's affinity for water as opposed to its saturated water capacity or “water content”. In order to compare hydrogel materials, a reliable method is needed to predict the on-eye behavior of lenses made from hydrogel materials.

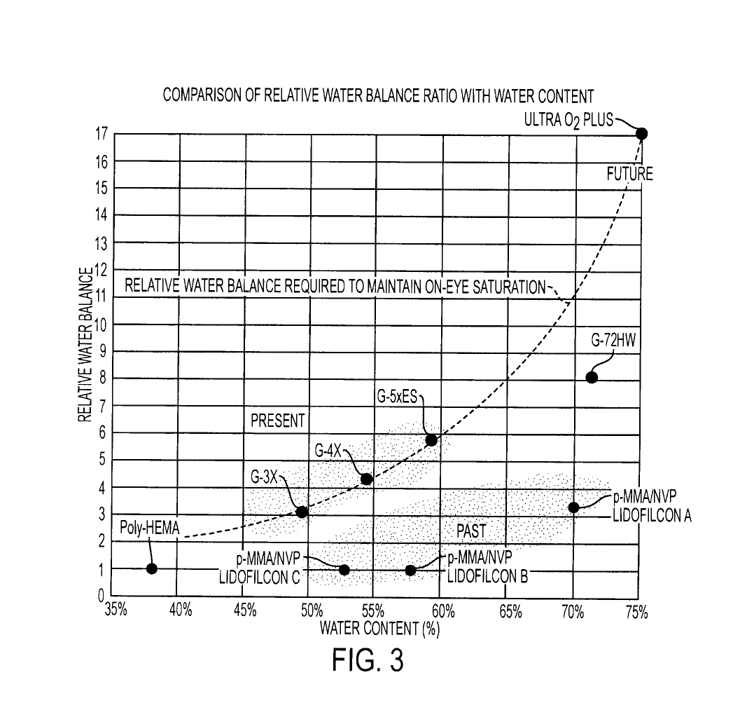

A method for predicting on-eye hydration of soft lens materials, known as relative water balance, can be defined as the time for a standardized test lens to dry by 10% of its water weight divided by the time for it to rehydrate, relative to a poly-HEMA control lens. The relative water balance of high performance lenses made of materials as described herein can be compared to other commercial materials (see for example FIG. 3 below, working examples). The benefit of the higher relative water balance of the lenses made of materials described herein can be, for example, higher on-eye water content, higher dimensional stability, greater oxygen transmissibility and much better wettability.

These and other parameters can serve as benchmarks for claiming the embodiments described herein.

Additional embodiments are described with respect to the following non-limiting working examples.

### Working Examples

Table 1 illustrates different hydrogels comprising GMA and/or EOEMA, MOEMA, and NN-DMA.

TABLE 1
Examples of hydrogels comprising GMA.

| | | | NN- | | | | | | |
|---|---|---|---|---|---|---|---|---|---|
| No. | GMA | EOEMA | DMA | MOEMA | Peg 200 | NMP | TriEGD | Initiator* | Water % |
| 1 | 74 | | 1 | 25 | 7 | 6 | 0.17 | 0.06 | 68 |
| 2 | 80 | | 5 | 15 | 7 | 6 | 0.17 | 0.06 | 75 |
| 3 | 80 | | | 20 | 7 | 6 | 0.17 | 0.06 | 67 |
| 4 | 76 | | | 24 | 7 | 6 | 0.17 | 0.06 | 66 |
| 5 | 82 | | 3 | 15 | 7 | 6 | 0.17 | 0.06 | 73 |
| 6 | 83 | 10 | 7 | | 7 | 5 | 0.17 | 0.06 | 75 |
| 7 | 90 | | | 10 | 7 | 5 | 0.17 | 0.06 | 68 |

*Initiator is 2,2′-azobis(2,4-dimethylpentane nitrile).
Wt. % is used.

Procedures were used as described in for example prior U.S. Pat. No. 6,096,799.

Relative Water Balance: Two samples were measured for relative water balance. See for example test method in U.S. Pat. No. 6,096,799 in working examples, which is hereby incorporated by reference in its entirety. One sample (no. 1) which had a water content of 68 wt. % had a relative water balance of 11, and another sample (no. 2) which had a water content of 75 wt. % had a relative water balance of 17.

### Polymer Rod Production Process

The polymer production process began with the preparation of the reaction vessels that contained the monomer. The monomer blend was charged into the reactor along with the initiator and/or tint and/or UV blocker where it was mixed and degassed. The mixture was dispensed into the reaction vessels where it was thermally polymerized using a computer controlled reactor. After polymerization, the polymer rods were removed from the reaction vessel to await the grinding process.

Grinding was carried out to grind to thickness. Grinding was also carried out to grind to diameter.

In some cases, glass molds were used. In other cases, plastic molds such as polypropylene molds were used.

Cloudiness was determined by initial visual inspection after swelling and also in actual use and wear.

### Production Method Working Example

### Materials and Amounts

GMA—222 g

TriEGDMA—0.51 g (crosslinker)

VAZO 52—0.18 g (initiator)

MOEMA—75 g

NMP—18 g

NN-DMA—3 g

PEG 200—7 g

### Polymerization Process:

The above materials were added to a glass apparatus where they were thoroughly mixed. Mixing was complete when the materials become a homogenous monomer blend. The monomer was degassed for 5 minutes.

After degassing, the monomer was carefully transferred to test tubes. The test tubes were placed into a temperature controlled reaction chamber for 20 to 30 hours @ 20 to 30° C. Once polymerization was complete, the temperature in the reaction chamber was raised to a post polymerization temperature of 92° C. for 4 hours.

The temperature in the reaction chamber was lowered to room temperature. The test tubes were removed. The polymerized rods were removed from the test tubes to await the grinding process.

### Grinding Process:

The polymerized rods were ground down to a specified diameter and then cut into pieces. The cut pieces or blanks were annealed at 85° C. for 5 hours. After annealing, blanks were ground to final dimensions of 12.7 mm diameter and 5.3 mm thickness.

### Contact Lens Water Content:

Contact lenses were cut out of the blanks and hydrated in saline. A water content of 68.8% was measured.

FIGS. 1-4 demonstrate additional advantages for at least one embodiment according to claimed subject matter relative to competitive materials.

What is claimed is:

1. A composition comprising at least one polymer prepared from at least the following monomers: 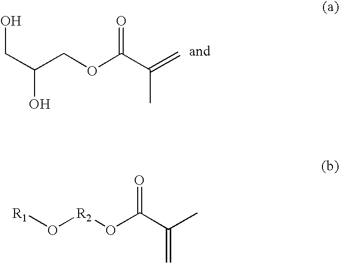
wherein R₁=—CH₃ or —CH₂CH₃ and R₂=—CH₂— or —CH₂—CH₂— or —CH₂—CH₂—CH₂—; but wherein the polymer is not prepared from hydroxyethyl methacrylate (HEMA).

2. The composition of claim 1, wherein the polymer is further prepared from (c) an acrylamide monomer.

3. The composition of claim 1, wherein the polymer is further prepared from (c) N,N-dimethylacrylamide.

4. The composition of claim 1, wherein the polymer is further prepared from (c) N,N-dimethylacrylamide, and wherein the amount of (c) is about 1 wt. % to about 20 wt. % based on the total amount of polymerizable monomers.

5. The composition of claim 1, wherein the amount of (a) is about 60 wt. % to about 95 wt. % and the amount of (b) is about 5 wt. % to about 40 wt. % based on the total amount of polymerizable monomers.

6. The composition of claim 1, wherein the polymer is further prepared from (c) N,N-dimethylacrylamide, and wherein the amount of (c) is about 1 wt. % to about 20 wt. % based on the total amount of polymerizable monomer, and wherein the amount of (a) is about 60 wt. % to about 95 wt. % and the amount of (b) is about 5 wt. % to about 40 wt. % based on the total amount of polymerizable monomers.

7. The composition of claim 1, wherein the composition further comprises at least one diluent.

8. The composition of claim 1, wherein the composition further comprises at least one diluent and at least poly(ethylene glycol).

9. The composition of claim 1, wherein the composition further comprises at least diluent and at least poly(ethylene glycol), the diluent and the poly(ethylene glycol) each present in an amount of about 1 wt. % to about 10 wt. % with respect to the total amount of polymerizable monomer.

10. The composition of claim 1, wherein the composition further comprises at least one polymer or oligomer substantially not reactive in polymerization of (a) and (b).

11. The composition of claim 1, wherein the composition further comprises at least one hydrophilic polymer or oligomer substantially not reactive in polymerization of (a) and (b).

12. The composition of claim 1, wherein the composition further comprises at least poly(ethylene glycol) having molecular weight of about 200 to about 400.

13. The composition of claim 1, wherein the composition further comprises at least poly(ethylene glycol) having molecular weight of about 200.

14. The composition of claim 1, wherein the polymer is prepared from at least one crosslinker and at least one polymerization initiator.

15. The composition of claim 1, wherein the composition has a water content of at least about 66 wt. %.

16. The composition of claim 1, wherein the composition has a water content of at least about 70 wt. %.

17. The composition of claim 1, wherein the composition has a water content of at least about 75 wt. %.

18. The composition of claim 1, wherein the polymer is further prepared from (c) N,N-dimethylacrylamide, and wherein the amount of (c) is about 1 wt. % to about 7 wt. % based on the total amount of polymerizable monomer, and wherein the amount of (a) is about 74 wt. % to about 90 wt. % and the amount of (b) is about 10 wt. % to about 25 wt. % based on the total amount of polymerizable monomers.

19. The composition of claim 1, wherein the polymer is further prepared from (c) N,N-dimethylacrylamide, and wherein the amount of (c) is about 1 wt. % to about 7 wt. % based on the total amount of polymerizable monomer, and wherein the amount of (a) is about 74 wt. % to about 90 wt. % and the amount of (b) is about 10 wt. % to about 25 wt. % based on the total amount of polymerizable monomers, wherein the composition further comprises at least one non-reactive diluent, at least one polymer or oligomer, and the polymer is prepared with use of at least one crosslinker and at least one polymerization initiator.

20. The composition of claim 1, wherein the polymer is further prepared from (c) N,N-dimethylacrylamide, and wherein the amount of (c) is about 1 wt. % to about 7 wt. % based on the total amount of polymerizable monomer, and wherein the amount of (a) is about 74 wt. % to about 90 wt. % and the amount of (b) is about 10 wt. % to about 25 wt. % based on the total amount of polymerizable monomers, wherein the composition further comprises at least one non-reactive diluent, at least one polymer or oligomer, and the polymer is prepared with use of at least one crosslinker and at least one polymerization initiator; and wherein the composition has a water content of at least about 70 wt. %.

21. A composition adapted for high hydrogel water content consisting essentially of at least one polymer prepared from at least the following monomers: 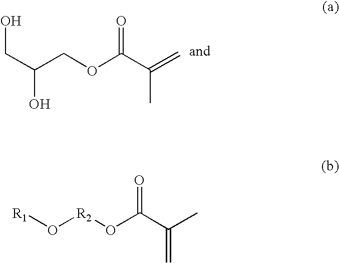
wherein R₁=—CH₃ or —CH₂CH₃ and R₂=—CH₂— or —CH₂—CH₂— or —CH₂—CH₂—CH₂—, wherein the water content is at least about 60 wt. % and any HEMA if used in the polymer preparation is about 2 wt. % or less with respect to the total amount of polymerizable monomers.

22. The composition of claim 21, wherein the polymer is further prepared from (c) an acrylamide monomer.

23. The composition of claim 21, wherein the polymer is further prepared from (c) N,N-dimethylacrylamide.

24. The composition of claim 21, wherein the polymer is further prepared from (c) N,N-dimethylacrylamide, and wherein the amount of (c) is about 1 wt. % to about 20 wt. % based on the total amount of polymerizable monomers.

25. The composition of claim 21, wherein the amount of (a) is about 60 wt. % to about 95 wt. % and the amount of (b) is about 5 wt. % to about 40 wt. % based on the total amount of polymerizable monomers.

26. The composition of claim 21, wherein the polymer is further prepared from (c) N,N-dimethylacrylamide, and wherein the amount of (c) is about 1 wt. % to about 20 wt. % based on the total amount of polymerizable monomer, and wherein the amount of (a) is about 60 wt. % to about 95 wt. % and the amount of (b) is about 5 wt. % to about 40 wt. % based on the total amount of polymerizable monomers.

27. The composition of claim 21, wherein the composition further consists essentially of at least one diluent.

28. The composition of claim 21, wherein the composition further consists essentially of at least one diluent and at least poly(ethylene glycol).

29. The composition of claim 21, wherein the composition further consists essentially of at least diluent and at least poly(ethylene glycol), the diluent and the poly(ethylene glycol) each present in an amount of about 1 wt. % to about 10 wt. % with respect to the total amount of polymerizable monomer.

30. The composition of claim 21, wherein the composition further consists essentially of at least one polymer or oligomer substantially not reactive in polymerization of (a) and (b).

31. The composition of claim 21, wherein the composition further consists essentially of at least one hydrophilic polymer or oligomer substantially not reactive in polymerization of (a) and (b).

32. The composition of claim 21, wherein the composition further consists essentially of at least poly(ethylene glycol) having molecular weight of about 200 to about 400.

33. The composition of claim 21, wherein the composition further consists essentially of at least poly(ethylene glycol) having molecular weight of about 200.

34. The composition of claim 21, wherein the polymer is prepared from at least one crosslinker and at least one polymerization initiator.

35. The composition of claim 21, wherein the composition has a water content of at least about 66 wt. %.

36. The composition of claim 21, wherein the composition has a water content of at least about 70 wt. %.

37. The composition of claim 21, wherein the composition has a water content of at least about 75 wt. % and a relative water balance of at least 16.

38. The composition of claim 21, wherein the polymer is further prepared from (c) N,N-dimethylacrylamide, and wherein the amount of (c) is about 1 wt. % to about 7 wt. % based on the total amount of polymerizable monomer, and wherein the amount of (a) is about 74 wt. % to about 90 wt. % and the amount of (b) is about 10 wt. % to about 25 wt. % based on the total amount of polymerizable monomers.

39. The composition of claim 21, wherein the polymer is further prepared from (c) N,N-dimethylacrylamide, and wherein the amount of (c) is about 1 wt. % to about 7 wt. % based on the total amount of polymerizable monomer, and wherein the amount of (a) is about 74 wt. % to about 90 wt. % and the amount of (b) is about 10 wt. % to about 25 wt. % based on the total amount of polymerizable monomers, wherein the composition further consists essentially of at least one non-reactive diluent, at least one polymer or oligomer, and the polymer is prepared with use of at least one crosslinker and at least one polymerization initiator, and the amount of HEMA is less than 1 wt. %.

40. The composition of claim 21, wherein the polymer is further prepared from (c) N,N-dimethylacrylamide, and wherein the amount of (c) is about 1 wt. % to about 7 wt. % based on the total amount of polymerizable monomer, and wherein the amount of (a) is about 74 wt. % to about 90 wt. % and the amount of (b) is about 10 wt. % to about 25 wt. % based on the total amount of polymerizable monomers, wherein the composition further consists essentially of at least one non-reactive diluent, at least one polymer or oligomer, and the polymer is prepared with use of at least one crosslinker and at least one polymerization initiator; and wherein the composition has a water content of at least about 70 wt. %, and the amount of HEMA is less than about 0.1 wt. %.

41. A hydrogel comprising a polymer with a backbone prepared from at least the following monomers and adapted for a high water content of at least 70% and a high relative water balance of at least 16: 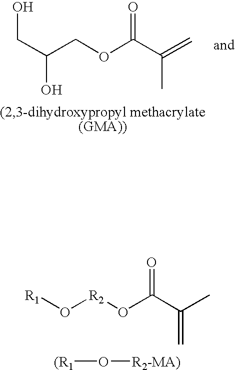
wherein R₁=—CH₃ or CH₃—CH₂— and R₂=—CH₂— or —CH₂—CH₂— or —CH₂—CH₂—CH₂—;

42. A method of making a contact lens, comprising:
(a) providing at least the following monomers: 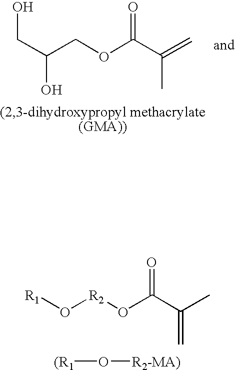
wherein R₁=—CH₃ or CH₃—CH₂— and R₂=—CH₂— or —CH₂—CH₂ or —CH₂—CH₂—CH₂—;
(b) polymerizing the monomers to form a polymer for a hydrogel; and
(c) placing the polymer for the hydrogel in a device and forming contact lens by molding, cutting, or lathing the hydrogel.

43. A method of improving vision in a patient, comprising:
(a) providing contact lens made of a hydrogel having at least the following monomers and adapted for a high water content of at least 70% and a high relative water balance of at least 16: 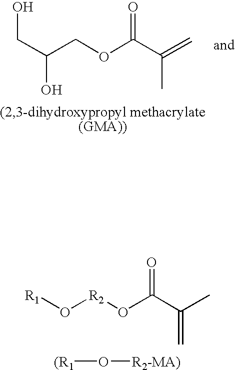
wherein R₁=CH₃ or CH₃—CH₂— and R₂=CH₂— or —CH₂—CH₂ or —CH₂—CH₂—CH₂—; and
(b) placing the lens in at least one of the patient's eyes.

44. A contact lens comprising a hydrogel, the hydrogel comprising at least one crosslinked polymer, wherein the crosslinked polymer comprises polymerized GMA, at least one polymerized hydrophobic monomer, and comprises substantially no polymerized HEMA.

45. The contact lens of claim 44, wherein the polymer further comprises polymerized NN-DMA.

46. The contact lens of claim 44, wherein the lens is adapted for a high water content of at least 70% and a high relative water balance of at least 16.
